(19) United States
(12) Patent Application Publication
(10) Pub. No.: US 2011/0055752 A1
(43) Pub. Date: Mar. 3, 2011

(54) Method and Apparatus for Displaying and Auto-Correcting an Over-Scroll State on a Computing Device

(76) Inventors: Jonathan J. Rubinstein, San Francisco, CA (US); Matias Duarte, Sunnyvale, CA (US); Robert Tsuk, Cupertino, CA (US)

(21) Appl. No.: 12/793,523

(22) Filed: Jun. 3, 2010

Related U.S. Application Data
(60) Provisional application No. 61/184,310, filed on Jun. 4, 2009.

(51) Int. Cl. G06F 3/048

(52) U.S. Cl. 715/784

(57) ABSTRACT

A computing device may execute an application to generate application content on a defined region of a display surface. The computing device may respond to a user-input to over-scroll the application content by displaying content that is indicative of an over-scroll state. Upon completion of a designated duration, the computing device automatically displays the application content in the defined region without the content that is indicative of the over-scroll state.

### RELATED APPLICATIONS

This application claims benefit of priority to Provisional U.S. Patent Application No. 61/184,310, filed Jun. 4, 2009; the aforementioned application being hereby incorporated by reference in its entirety.

### TECHNICAL FIELD

The disclosed embodiments relate to computing devices, and user-interfaces for computing devices. In particular, embodiments described herein provide a method and apparatus for displaying and auto-correcting an over-scroll state on a computing device.

### BACKGROUND

Computing devices, particularly mobile computing devices and other small form-factor computing devices, often require heavy use of scroll input from a user. Generally, scroll input allows for users to linearly navigate the display of content on a computing device. In mobile computing devices, for example, much of the user's actions are centered about selecting and viewing data or content. Lists, such as those that comprise contact records or messages, are examples of computing device content that is typically scrollable in north/south (and sometimes east/west) directions in order to enable the user to scan and view numerous records with ease.

### BRIEF DESCRIPTION OF THE DRAWINGS

FIG. 1 illustrates a method for displaying and automatically correcting an over-scroll state on a computing device, according to an embodiment.

FIG. 2A through FIG. 2C illustrate implementation of a user-interface of a computing device, under an embodiment.

FIG. 3A through FIG. 3C illustrates a user-interface of a computing device that presents an over-scroll state using a visual continuum of content with a surrounding region, before automatically correcting the over-scroll state, according an embodiment.

FIG. 4 illustrates a computing device configured to implement one or more embodiments described herein.

FIG. 5 illustrates a hardware diagram for a mobile computing device that is configured to support any of the embodiments described herein.

### DETAILED DESCRIPTION

Embodiments described herein provide for a computing device to display and auto-correct an over-scroll state.

According to embodiments described herein, a computing device is configured to execute an application and display associated application content that is scrollable in one or more directions (e.g. north/south, optionally east/west). The displayed application content (e.g. list of entries or records) may be scrollable into an over-scroll state. The over-scroll state corresponds to a state in which, as a result of a magnitude of the user's scroll input, the boundary of the application content has been exceeded. Rather than, for example, ignoring the over-scroll input, one or more embodiments provide for the device to present the user with content that represents the boundary of the application content having been exceeded. Such content, which is indicative of the over-scroll state, is displayed for a designated duration, after which the application content is re-displayed.

In an embodiment, a computing device includes an input interface which may be integrated or formed as part of a display (e.g. touch-sensitive display). The computing device may include one or more processors that are configured to execute an application that provides an application content on at least a portion of the display. The processor(s) accept one or more inputs, entered by the user moving a finger or object on the input interface, to scroll the application content. The processor(s) enable a user to enter an input to over-scroll beyond a boundary of the application content. In response to the user entering the input to over-scroll, the processor(s) (i) display, for a designated duration, content that is indicative of an over-scroll state; then (ii) automatically return to displaying at least a portion of the application content, without the content that is indicative of the over-scroll state, upon completion of the designated duration.

Still further, in another embodiment, a computing device may execute an application to generate application content on a defined region of a display surface. The computing device may respond to a user-input to over-scroll the application content by displaying content that is indicative of an over-scroll state. Upon completion of a designated duration, the computing device automatically displays the application content in the defined region without the content that is indicative of the over-scroll state.

As used herein, the terms “programmatic”, “programmatically” or variations thereof mean through execution of code, programming or other logic. A programmatic action may be performed with software, firmware or hardware, and generally without user-intervention, albeit not necessarily automatically, as the action may be manually triggered.

One or more embodiments described herein may be implemented using programmatic elements, often referred to as modules or components, although other names may be used. Such programmatic elements may include a program, a subroutine, a portion of a program, or a software component or a hardware component capable of performing one or more stated tasks or functions. As used herein, a module or component, can exist on a hardware component independently of other modules/components or a module/component can be a shared element or process of other modules/components, programs or machines. A module or component may reside on one machine, such as on a client or on a server, or may alternatively be distributed amongst multiple machines, such as on multiple clients or server machines. Any system described may be implemented in whole or in part on a server, or as part of a network service. Alternatively, a system such as described herein may be implemented on a local computer or terminal, in whole or in part. In either case, implementation of system provided for in this application may require use of memory, processors and network resources (including data ports, and signal lines (optical, electrical etc.), unless stated otherwise.

Furthermore, one or more embodiments described herein may be implemented through the use of instructions that are executable by one or more processors. These instructions may be carried on a computer-readable medium. Machines shown in figures below provide examples of processing resources and computer-readable mediums on which instructions for implementing embodiments of the invention can be carried and/or executed. In particular, the numerous machines shown with embodiments of the invention include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash memory (such as carried on many cell phones and personal digital assistants (PDAs)), and magnetic memory. Computers, terminals, network enabled devices (e.g. mobile devices such as cell phones) are all examples of machines and devices that utilize processors, memory, and instructions stored on computer-readable mediums.

Methodology

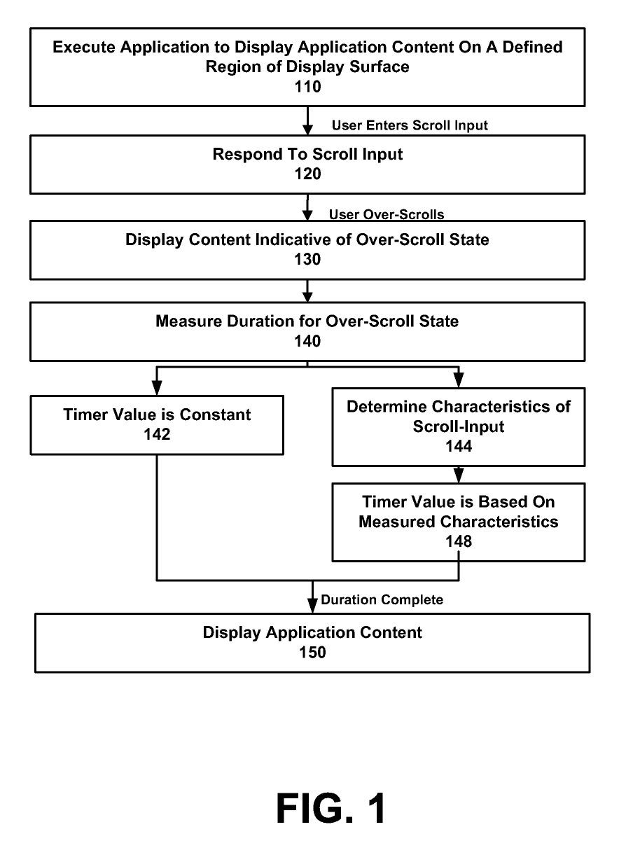

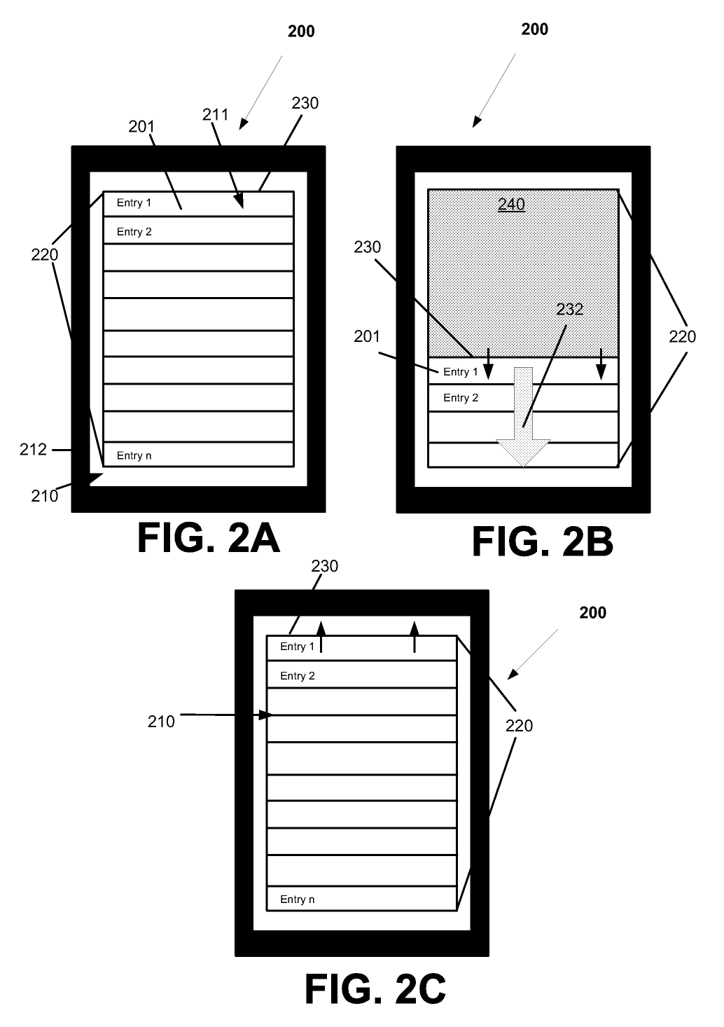

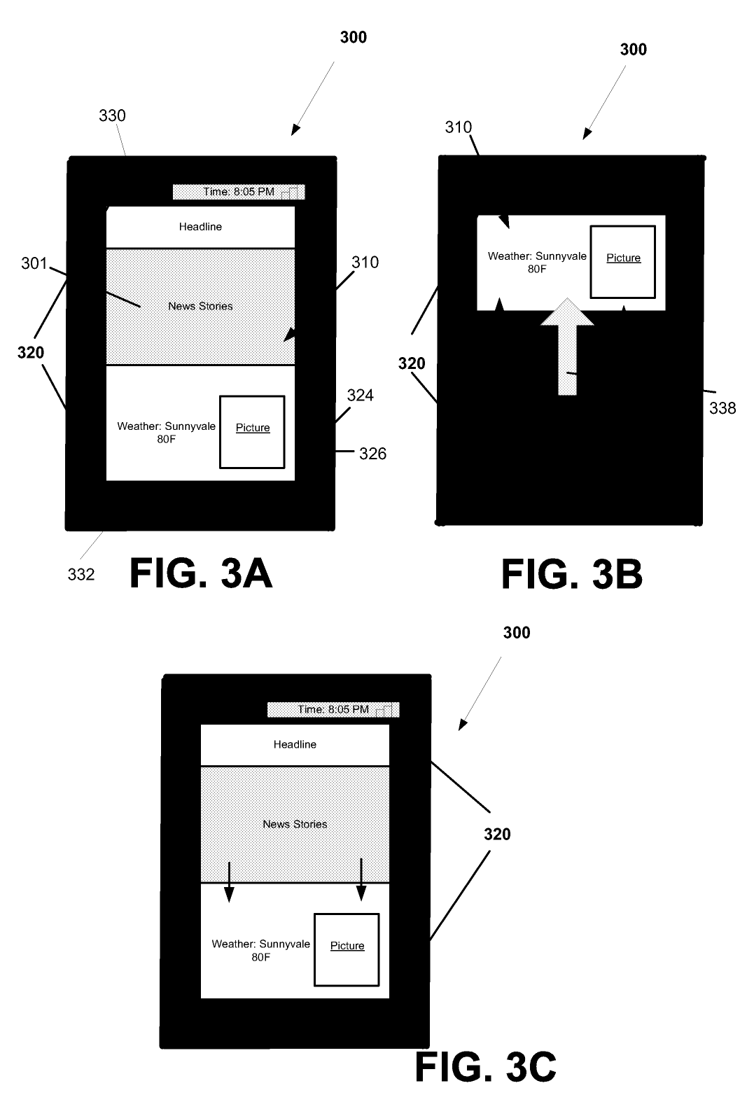

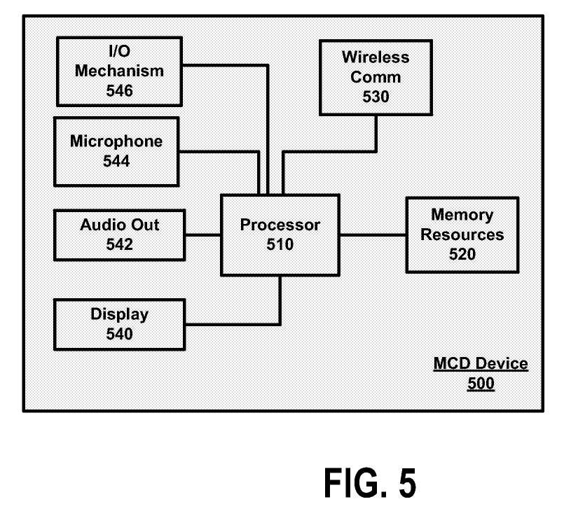

FIG. 1 illustrates a method for displaying and automatically correcting an over-scroll state on a computing device, according to an embodiment. A computing device for implementing an embodiment of FIG. 1 may correspond to, for example, a mobile or small-form factor computing device, such as described with embodiments of FIG. 5. A method such as described with FIG. 1 assumes that the computing device includes an input interface that is capable of receiving directional input in the form of the user moving a finger or object over the interface. As described with an embodiment of FIG. 5, the input interface may correspond to a touch-sensitive display. FIG. 2A-2C and FIG. 3A-3C illustrate examples of how a method such as described with FIG. 1 may be implemented.

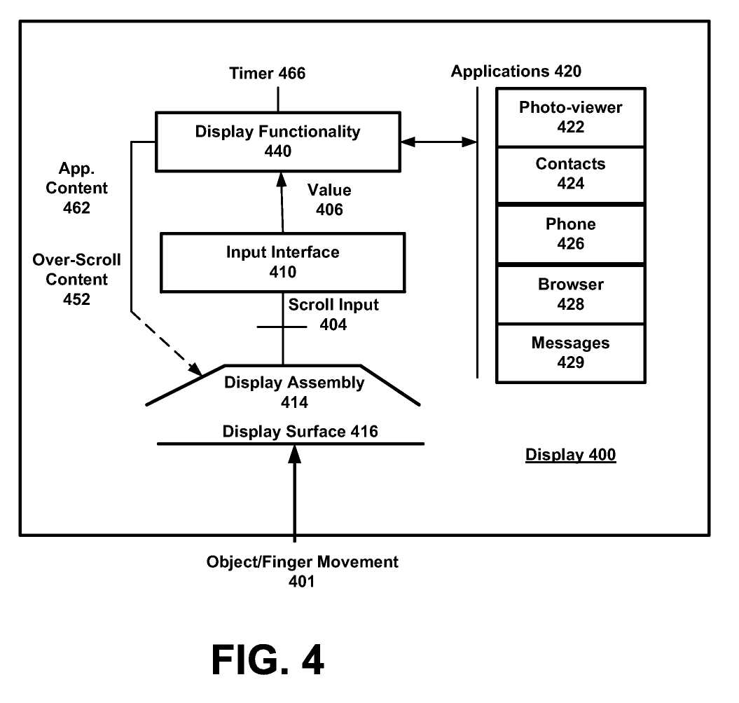

Step 110 provides that a computing device executes an application to display application content in a defined region of a display surface. The application content may correspond to, for example, a document or record view, or list (see e.g. FIG. 4). The defined region of the display surface may correspond to a discrete portion of the display (e.g. rectangular sub-region) or the entire display surface. While the region for the display of application content is defined, embodiments contemplate that the user can manipulate the size, dimensions or presentation of the defined region. In one implementation, the application content is generated to appear in a defined region that is rectangular, and which occupies some or all of the available display space (see e.g. FIG. 2A, FIG. 3A) on the computing device.

In an embodiment, the application is scrollable, meaning it is receptive to directional input entered onto an input interface. In an embodiment, the computing device uses a touch-sensitive display as an input interface, and the directional input corresponds to the user swiping or moving a finger in a general direction of the intended scroll. More generally, a contact-sensitive display may be used as the input interface, and the user may enter the directional input by moving a corresponding object (including a finger) over the display. Still further, the input interface may be provided as a touchpad or contact-sensitive region that is separate from the display area.

Step 120 provides that processing resources of the computing device respond to directional input entered to scroll the application content on the display surface. For example, the application content may be moved upward or downward in a direction that generally coincides with the direction of the user's input movement. However, application content generally includes boundaries (i.e. borders indicating a top or bottom of the content provided by the application), and the user's directional input may sometimes approach or exceed the application boundary. In the case where the application content is a list of entries (e.g. list of contact records or emails), the boundary of the application content coincides with the first and last entry. In the case where the application content is a document or image, the boundary may correspond to the edges of the document/image. If the user's directional input causes a magnitude of the scroll action to exceed the boundary of the application content, the computing device displays content for over-scroll state.

More specifically, step 130 provides that the device displays content that is indicative of the over-scroll state. Such over-scroll content may correspond to, for example, dead or empty space (FIG. 2B) that occupies a portion of the defined region in which the application content is presented. In one alternative variation (depicted by FIG. 3B), the over-scroll content is generated to be a visual continuum of the surrounding space of the application content.

According to embodiments, the presentation of the over-scroll state is temporary and self-correcting. Upon the over-scroll state being displayed, a timer is initiated in step 140 to measure the completion of a designated duration of time. The designated duration of time may be relatively short (e.g. between 250-750 milliseconds). In one embodiment, the designated duration of time is constant, so that its passage (step 142) does not change between different occurrences of the over-scroll state. In another embodiment, however, the designated duration may be based in part on one or more characteristics of the scroll input from the user's finger or from an input object. The one or more characteristics may coincide with a magnitude of the scroll input that causes the over-scroll state. Still further, in one embodiment, a velocity of the motion of the finger/object that caused the over-scroll state may be measured (step 144), and the designated duration may be determined based on the measured velocity (step 148). In one embodiment, a faster motion of the scroll input that causes the over-scroll state results in a shorter designated duration, as compared to the same directional input having occurred as a result of a slower motion. The assumption under such an implementation is that the user's velocity motion is indicative of the user's preferred response time to the scroll-input. In either case, the over-scroll state may be displayed for a relatively short duration (e.g. 350 ms for fast scroll motion, 650 ms for slow scroll motion).

Then, step 150 provides that the application content is scrolled back so that the defined region on which the application content is presented includes only the application content, and not the over-scroll content. The scroll back may correspond to scrolling the application content in the reverse direction of the user's directional input. The portion of the application content that is displayed after the scroll-back may be the content that is adjacent to the boundary that was over-scrolled. The application content may be displayed without content that is indicative of the over-scroll state.

According to one embodiment, the scroll back occurs automatically, and independent of the presence of the user's finger or object that entered the directional input. For example, if the user attempts to maintain upward motion with the finger contact in order to continue the scroll action when the over-scroll content is presented, the performance of step 150 is not deterred. Likewise, if the user lifts his finger (or otherwise stops entering the directional input) before completion of the designated duration, one embodiment provides that the performance of step 150 is not accelerated. As an alternative or variation, however, one embodiment provides that the performance of step 150 may be accelerated upon the user stopping the directional input (e.g. lifting his finger).

User-Interface Examples

FIG. 2A through FIG. 2C illustrate implementation of a user-interface of a computing device, under an embodiment. In FIG. 2A-2C, a computing device responds to an over-scroll input from a user's fingers or from an input object and automatically presents over-scroll content corresponding to an over-scroll state.

In FIG. 2A, application content 210 is presented on a display surface 212 of a computing device 200. In the example shown, the application content 210 corresponds to a list 201 of entries 211 (e.g. list of contacts, list of phone calls made, list of messages etc.). The user interface feature being described may be equally applicable to other forms of content (e.g. web page or document viewing such as described with FIG. 3A-3C). The application content 210 is presented in a defined region 220, corresponding to a space or region on the display surface. In the example depicted, scrolling is performed by the user entering directional input in the north or south direction. The application content 210 includes a north boundary 230 (representing the first entry) and a south boundary (not shown, representing the last entry). As displayed, the application content 210 may be scrolled downward (i.e. south) to present to the user entries that are not visible in the defined region. If the user attempts to scroll downward past the application boundary 230, however, over-scroll content 240 is presented and dismissed, as described with FIG. 1.

FIG. 2B illustrates presentation of the over-scroll content in the over-scroll state, under an embodiment. In an implementation shown, the over-scroll state is initiated when the user enters directional input 232 to scroll downward from the first entry 201. The computing device 200 permits the scroll action by moving the first entry down (along with the north boundary), thus entering the over-scroll state and presenting the over-scroll content. The defined region 220 is maintained in its dimension, but over-scroll content 240 is used to indicate the over-scroll state. In an embodiment, the over-scroll content 240 is blank or dead space.

Once the over-scroll state is initiated, a timer is started to automatically correct the over-scroll state. For one embodiment, the time period in which the over-scroll state is maintained is independent of the user's directional input that causes the over-scroll state. For example, if the user continues to enter directional input after the over-scroll state is initiated, the duration for which the over-scroll state is active would not be affected. However, as mentioned with an embodiment of FIG. 1, while some embodiments provide for the timer of the over-scroll state to be constant (i.e. the same temporal value for each occurrence), other embodiments enable the use of a varied timer that depends on the velocity (or other characteristic) of the directional input 232. Thus, for example, the value of the designated duration may be set by the velocity of the directional input 232. In one implementation, faster velocity may shorten the designated duration in which the over-scroll state is maintained.

FIG. 2C illustrates the application content 210 scrolling back (i.e. the dismissal of the over-scroll content 240) after completion of the designated duration. The scroll-back of the application content 210 is automatic, upon completion of the designated duration. In the scroll-back, application content 210 is scrolled in the opposite direction of the input 232 that caused the over-scroll state. In the implementation shown, the defined region 220 is occupied with the over-scrolled boundary positioned to occupy the coinciding boundary of the defined region (e.g. north boundary 230 is at the north edge of the defined region 220).

FIG. 3A through FIG. 3C illustrates a user-interface of a computing device that presents over-scroll content using a visual continuum of content from a surrounding region of the application content. As described by some other embodiments, content corresponding to the visual continuum is used to indicate the over-scrolled state, prior to the expiration of a designated duration after which the over-scroll state is terminated and the over-scroll content is dismissed. In FIG. 3A, application content 310 is presented on a display surface of a computing device 300. In the example shown, the application content 310 corresponds to a web page 301 (although other forms of content, such as lists (see FIG. 2A-2C) are equally applicable). The application content 310 (or portions thereof) is presented in a defined region 320, corresponding to a space or region on the display surface. In the example depicted, scrolling is performed by the user entering directional input in the north or south direction (other directions may also be entered in other implementations). The application content 310 includes a north boundary 330 (representing the top border of the web page) and a south boundary 332 (representing the bottom of the web page). The application content 310 is scrollable in two (north, south) or more (north, south, east west) directions. In the example shown, the application content 310 is segments or portions that depict different kinds of content (e.g. headline, news story and local weather).

In the example shown by FIG. 3A-3C, the defined region 320 on which the application content 310 is presented includes surrounding region 324. The surrounding region 324 may be computer-generated, and include background display content, such as a graphic theme or color. A housing perimeter 326 may encircle the surrounding region 324.

FIG. 3B illustrates an implementation of the over-scroll state, corresponding to when the user enters upward directional input 338 resulting in the south boundary 332 (and content appearing adjacent next to the boundary) being moved north. The computing device may permit the south boundary 332 and adjacent content to be moved north a set amount. In this over-scroll state, portions of the defined region 320 that are not application content are not blank or white space. In particular, portions of the defined region 320 that are not application content are filled with content that visually matches or shares characteristics (e.g. color or pattern) with the surrounding region 324, so as to create a visual continuum of the surrounding region 324. A visual transition may be presented to display the over-scroll state. In one implementation, movement of either boundary 330, 332 results in an appearance that the defined region 320 shrinks. Portions of the defined region 320 that do not display application content 310 display content that matches the surrounding region 324, or content that is similar to it so as to form the visual continuum. Still further, the surrounding region 324 may be an extension of the appearance of the housing façade 326 (e.g. both may be black). Thus, the visual continuum that is formed may extend to the housing façade.

In another implementation, information (e.g. the time, cellular strength) displayed in the surrounding region 324 during the over-scroll state may be moved into the defined region to coincide with the directional input from the user.

FIG. 3C illustrates the application content 310 scrolling back after completion of the designated duration. As with implementations described with FIG. 2A-2C, the scroll-back of the application content 310 is automatic, upon completion of the designated duration. The scroll back may also be performed to present a visual transition. As described with other embodiments, the duration may be based on a timer that is initiated with the onset of the over-scroll state. In some implementations, the duration is constant, and in other implementations, the duration is varied (based on characteristics such as velocity of the directional input). During the scroll-back, application content 310 is scrolled in the opposite direction of the input 338 that caused the over-scroll state. In the implementation shown, the application content is returned so that the over-scrolled boundary 330 is positioned at the corresponding edge of the defined region, and content adjacent to the boundary 330 occupies the remainder of the defined region 320.

Device Description

FIG. 4 illustrates a computing device configured to implement one or more embodiments described herein. The computing device 400 may correspond to, for example, a mobile computing device such as described with FIG. 5 and elsewhere in this application. According to an embodiment, a computing device 400 includes input interface 410 that provides an interface to receive scroll input corresponding to a motion of a user's finger (or other skin) or object. Depending on the implementation, numerous other kinds of input may also be received, such as for example, selection input, alphanumeric entry (which may also be entered as selection input), or biometric input (to validate the user). As described with FIG. 5, an embodiment provides that the input interface 410 is combined or integrated with a display assembly 414 that provides a display surface 416 for enabling output.

The device 400 may enable any one of a plurality of applications, including applications that can receive and respond to directional input 404 in order to scroll. The scroll input 404 may be determined from the user's finger/object movement 401 over the display surface (which is part of the input interface 410). In general, numerous applications may receive scroll input 404 to enable content generated from the application to be moved in one direction or another. The following provides some examples of applications that can execute to use scroll (or directional) input in accordance with embodiments described. A photo viewer 422, for example, may receive scroll input to enable the user to view specific regions of an image (e.g. enable the user to move about an image, or from image to image). A contact application 424 may display contact records in list form which can then be scrolled in north/south directions. Individual contact records, and data items retained by the contact records, may be opened and viewed with scroll input. A phone application 426 may, for example, incorporate phone entries in list form that can be scrolled. A browser 428 (or document viewer) may enable the user to scroll in many directions to view contents on a page. A messaging application 429 (e.g. email, SMS, MMS, IM, integrated messaging platform etc.) may display messages in list form, and may enable individual messages to be viewed and scrolled. Numerous other examples of applications, and/or the use of scroll or directional input exist.

According to an embodiment, display functionality 440 may be included or otherwise integrated with the individual applications 420 to scroll application content in response to scroll input 404. The scroll input 404 may be interpreted as a value 406 from which, for a given application being executed, application content 462 and other determinations may be made. In particular, one or more embodiments provide that the display functionality 440 includes logic that (i) presents application content 462, including content that represents scrolling of the application content in response to the scroll input 404; (ii) identifies the occurrence of an over-scroll state; and (iii) when the over-scroll state occurs, generate content that is indicative of the over-scroll state (over-scroll content 452). In some embodiments, the execution of one application 420 occurs in a defined region on the display, and the over-scroll content 452 is provided within a portion of that defined region. In addition to generating the over-scroll content 452, the display logic may provide visual effects, particularly motion, that transitions the over-scroll content 452 into the defined region in place of the application content 462, so as to simulate or represent the over-scroll content 452 as being scrolled into place in the defined region. Still further, one or more embodiments provide that over-scroll content 452 is designed to provide a visual continuum with a surrounding space of the defined region. As described with an embodiment of FIG. 3A-3C, the surrounding region of the visual continuum may extend to the appearance of the physical structure of the housing façade.

According to embodiments, the display functionality 440 maintains a timer 466 to set the duration for which the display of over-scroll content 452 is maintained. Once the duration is complete, the display functionality 440 returns to displaying application content 462 from the particular application that receives the scroll input 404 in the defined region. As with the display of over-scroll content 452, the return of the application content 462 may be depicted as a transition motion.

In some embodiments, the duration for which the display of over-scroll content 452 is maintained is based at least in part on characteristics of the user's scroll input 404. In one implementation, the characteristic may correspond to velocity of the scroll input 404. With faster velocity on the user's input 404, the designated duration for display of over-scroll content 452 is shortened (as compared to slower velocity user input).

FIG. 5 illustrates a hardware diagram for a computing device that is configured to support any of the embodiments described herein. An embodiment of FIG. 5 is depicted as a mobile computing device 500, which may correspond to any device that includes roaming wireless network and/or telephony capabilities, including cellular telephony devices and/or mobile messengers. In particular, embodiments described herein may apply to numerous kinds of mobile or small form-factor computing devices. One type of mobile computing device that may be configured to include embodiments described herein includes a computer telephony device, such as a cellular phone or mobile device with voice-telephony applications (sometimes called “smart phone”). A computing device such as described may be small enough to fit in one hand, while providing cellular telephony features in combination with other applications, such as messaging, web browsing, media playback, personal information management (e.g. such as contact records management, calendar applications, tasks lists), image or video/media capture and other functionality. Mobile computing devices in particular may have numerous types of input mechanisms and user-interface features, such as keyboards or keypads, mufti-directional or navigation buttons, application or action buttons, and contact or touch-sensitive display screens. Some devices may include combinations of keyboard, button panel area, and display screen on one façade. The button panel region may occupy a band between the keypad and the display area, and include a navigation button and multiple application buttons or action buttons.

Specific types of messaging that may be performed include messaging for email applications, Short Message Service (SMS) messages, Multimedia Message Service (MMS) messages, and proprietary voice exchange applications (such as SKYPE). Still further, other types of computing devices contemplated with embodiments described herein include laptop or notebook computers, ultra-mobile computers, personal digital assistants, and other mufti-functional computing devices.

Still further, one or more embodiments may be implemented through any type of computing device such as a desktop computer that is configured to include real-time voice data exchange (e.g. through use of Internet Protocol telephony). Still further, other types of computer telephony devices exist, including standalone devices that connect directly to a telephone network (whether Internet Protocol or Public Switch Telephony System (PSTN)) and provide software interfaces and applications.

According to an embodiment, the device 500 may include one or more processors 510 (as processing resources), memory resources 520, one or more wireless communication ports 530, and various other input/output features, including a display assembly 540, a speaker 542, a microphone 544 and other input/output mechanisms 546. According to one or more embodiments, the display assembly 540 includes a touch-sensitive display interface to receive human contact (or close proximity) as input. More specifically, the display assembly 540 provides an interface by which the user may enter directional input for scrolling actions. These directional inputs may be entered by, for example, the user swiping or moving a finger in a particular direction that coincides (or is interpreted to coincide) with a particular linear direction. As described with embodiments above, the processor(s) may process the inputs to present application content in defined regions, simulate scrolling, and display over-scroll content when the user has over-scrolled.

It is contemplated for embodiments described herein to extend to individual elements and concepts described herein, independently of other concepts, ideas or systems, as well as for embodiments to include combinations of elements recited anywhere in this application. Although illustrative embodiments of the invention have been described in detail herein with reference to the accompanying drawings, it is to be understood that the invention is not limited to those precise embodiments. As such, many modifications and variations will be apparent to practitioners skilled in this art. Accordingly, it is intended that the scope of the invention be defined by the following claims and their equivalents. Furthermore, it is contemplated that a particular feature described either individually or as part of an embodiment can be combined with other individually described features, or parts of other embodiments, even if the other features and embodiments make no mention of the particular feature. This, the absence of describing combinations should not preclude the inventor from claiming rights to such combinations.

What is claimed is:

1. A computing device comprising:
an input interface;
one or more processors configured to:
execute an application that provides an application content on at least a portion of the display;
accept one or more inputs, entered by the user moving a finger or object on the input interface, to scroll the application content;
enable a user to enter an input to over-scroll beyond a boundary of the application content;
respond to the user entering the input to over-scroll by:
(a) displaying, for a designated duration, content that is indicative of an over-scroll state; then
(b) automatically returning to display at least a portion of the application content, without the content that is indicative of the over-scroll state, upon completion of the designated duration.

2. The computing device of claim 1, wherein the input interface includes the display, and wherein the display is touch-sensitive.

3. The computing device of claim 2, wherein the input to over-scroll corresponds to the user moving a finger over the touch-sensitive display in a direction of the scroll.

4. The computing device of claim 1, wherein the one or more processors are configured to:
execute the application to generate the application content on a defined region of a display surface;
respond to the user entering the input to over-scroll by displaying the content that is indicative of the over-scroll state in a portion of the defined display region.

5. The computing device of claim 4, wherein the one or more processors are configured to display at least some of the application content that is adjacent the boundary of the application content in the defined region, at the same time that the content that is indicative of the over-scroll state is being displayed in the defined region.

6. The computing device of claim 4, wherein the one or more processors are configured to respond to the user entering the input to over-scroll by automatically returning to display the application content that is adjacent to the boundary of the application content in the defined display region, in place of the content that is indicative of the over-scroll state.

7. The computing device of claim 4, wherein the content that is indicative of the over-scroll state corresponds to a visual continuum of a surrounding region to that of the defined region for the application content.

8. The computing device of claim 7, wherein the one or more processors are configured to display the visual continuum of the surrounding region as a graphic simulation of a housing façade that surrounds the display surface.

9. The computing device of claim 7, wherein the one or more processors are configured to display the visual continuum to create a visual affect of the defined region shrinking and the surrounding region expanding when the over-scroll state occurs.

10. The computing device of claim 1, further comprising a display assembly that includes the input interface and the display surface.

11. The computing device of claim 10, wherein the input interface and the display surface are combined.

12. The computing device of claim 1, wherein the one or more processors are configured to determine information about the user moving the finger or object as the input to over-scroll, and wherein a value of the designated duration is determined based in part on the information.

13. The computing device of claim 1, wherein the determined information corresponds to a determination of velocity of the finger or object being moved over the input interface.

14. A method for operating a computing device, the method being implemented by one or more processors and comprising:
executing an application to generate application content on a defined region of a display surface of the computing device;
responding to a user-input to over-scroll the application content by displaying content that is indicative of an over-scroll state; then
upon completion of a designated duration, automatically displaying the application content in the defined region without the content that is indicative of the over-scroll state.

15. The method of claim 14, further comprising determining the designated duration based on one or more characteristics of the user-input.

16. The method of claim 14, wherein displaying content that is indicative of the over-scroll state includes displaying content that presents a visual continuum with a surrounding region of the defined region.

17. The method of claim 14, wherein automatically displaying the application content includes visually transitioning from the over-scroll state to displaying the application content.

18. The method of claim 14, wherein responding to user-input includes responding to the user entering directional input with finger contact on the display surface.
